(19) United States
(12) Patent Application Publication
(10) Pub. No.: US 2007/0223678 A1
(43) Pub. Date: Sep. 27, 2007

(54) Call-Back Method in a Communication System

(76) Inventors: Erik Brunnekreef, Alcabideche (PT); Sven Donhuysen, Riehen (CH); Rob Snijder, Dietlikon (CH)

Correspondence Address: Berenato, White & Stavish, 6550 Rock Spring Drive, Suite 240, Bethesda, MD, 20817, US

(21) Appl. No.: 11/631,406

(22) PCT Filed: Jul. 1, 2005
(86) PCT No.: PCT/EP05/07124

§ 371 Date: Jan. 3, 2007

(30) Foreign Application Priority Data
Jul. 5, 2004 (DE) 10 2004 032 608.8

(51) Int. Cl. H04M 3/48

(52) U.S. Cl. 379/210.01

(57) ABSTRACT

This invention relates to a call-back method in a communication system for purposes of establishing a communication connection between a calling terminal (A) and a called terminal (B, C) accessible by a telephone number by switching of at least one exchange (E), whereby the telephone number is simply entered in the calling terminal (A) to initiate the communication connection and this activates transmission of a data set to the exchange and said data set then enables the exchange (E) to activate a call-back to the calling terminal (A) and a call to the called terminal (B, C) and to establish the communication connection between the two terminals (A, B or C), which is characterised in that after the telephone number has been entered in the calling terminal (A), the data set is automatically added to it and the resultant data message is transmitted to the exchange (E).

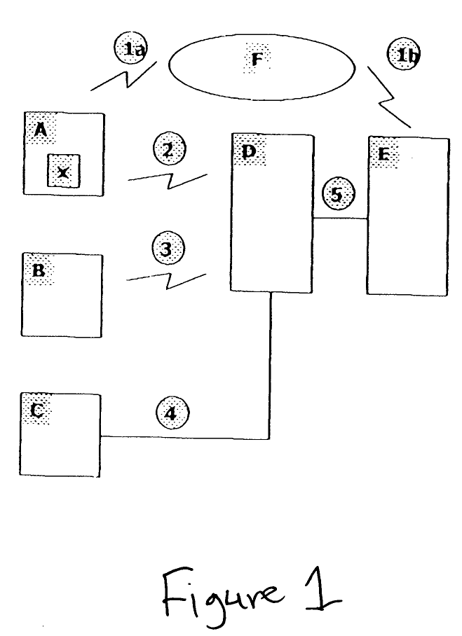

The invention relates to a call-back method in a communication system for purposes of establishing a communication connection between a calling terminal and a called terminal accessible by a telephone number by switching through at least one exchange, whereby the telephone number is simply entered in the calling terminal to initiate the communication connection and this activates transmission of a data set to the exchange and said data set then enables the exchange to activate a call-back to the calling terminal and a call to the called terminal and to establish a communication connection between the two terminals.

A call-back method is based on the fact that telephone calls from one country—for example from Germany—to another country—for example the USA—are considerably more expensive than in the other direction, for example a call from the USA to Germany. To take advantage of the cheaper rates from a foreign exchange—in this example the USA—the call-back method is used. By the said method, an exchange in the country with the low rates is keyed from the calling terminal—which may in particular be a mobile phone—which then rings off after the first ringing tone. The exchange first calls the called terminal and then calls the caller back and when he picks up establishes a connection with the called terminal. In general, another exchange is also interconnected in the caller's country. Nevertheless, greatly reduced telephone charges are incurred, particularly in the said example of a connection from Germany to the USA.

With the call-back method it is necessary both to give the exchange implementing the call-back the telephone number of the called terminal and to communicate a data set comprising the commands initiating the call-back and identification data for the calling terminal. Said data set enables the foreign exchange to implement the call-back to the calling terminal.

The call-back methods in the prior art differ basically according to how the telephone number of the called terminal and the data set described above are forwarded to the foreign exchange. In the call-back method according to WO 92/01350, the caller is required to enter a data message in his terminal which consists of the telephone number of the called terminal and the data set described above. For example, this can be the following data message: #123#+491791234567*. After establishment of the outgoing call connection, this data message is transmitted to the exchange, which then initiates the call-back from the foreign exchange on the basis of the message as soon as the caller has rung off after one ringing tone.

The disadvantage of this method is that the data message is very complicated and the communication connection is naturally not made if any one of the characters in the message is entered incorrectly or omitted. In addition the caller must actively break the outgoing call connection and actively answer the call-back, which is cumbersome and only operable by a person who knows the system.

The same disadvantages affect a call-back method whereby the foreign exchange is first called, entering the data set (without the telephone number of the called terminal) and after ringing off the exchange calls the calling terminal back and the telephone number is not keyed in until the call-back connection is established (www.rothenbacher.de).

To avoid the above disadvantages, an improved method is described in EP 1 062 822 B1 whereby the call-back method may be activated simply by entering the telephone number of the called terminal. By this method the terminal used as the calling terminal has an additional electronic circuit to control the call-back process. The data set for initiation of the call-back process is stored in said circuit. There is also a memory in which the telephone number of the called terminal is stored when it is entered via the input interface, e.g. the keypad.

The call-back process is initiated simply by entering the telephone number of the called terminal in the calling terminal. A connection is then established to the foreign exchange through the electronic circuit and the data set is transmitted for activation of the call-back and identification of the calling terminal. The connection is then automatically broken and call-back of the exchange follows. As soon as the call-back connection is established, the stored telephone number of the called terminal is read from the memory in the calling terminal and transmitted to the exchange. The called terminal is then called by the exchange and when the connection is established, a direct connection is made between the two terminals.

The disadvantage of this method is that it proceeds relatively slowly due to the fact that during the call-back the telephone number of the called terminal has to be read out first and only then can the called terminal be called. Apart from the resultant costs, the duration of this process misleads the caller into assuming that the connection is not working and he terminates the connection process.

Therefore the purpose of the invention is to design a call-back method of the aforementioned type so that the communication connection between the two terminals is established much more quickly. A further purpose consists of providing a terminal which is suitable for implementation of said call-back method.

This purpose is fulfilled according to the invention in that after the telephone number of the called terminal has been entered in the calling terminal, the data set intended to initiate the call-back is automatically added to it and the resultant data message is transmitted to the exchange. The basic concept of the invention is therefore to design the calling terminal—for example by means of an additional electronic circuit and/or a software program—so that simply by entering the telephone number of the called terminal, a data message is automatically generated which enables the exchange not only to implement the call-back but also to call the called terminal immediately and connect the two terminals with each other. This method operates much more quickly than the method according to EP 1 062 822 B1, so that costs can be saved and irritation avoided.

In an embodiment of the invention it is provided that after transmission of the data message the connection from the calling terminal to the exchange is severed automatically by the calling terminal, that is without operating it by ringing off. This makes it easier for the user of the calling terminal. Further simplification may be achieved if a call-back connection is established automatically by the calling terminal following the call-back by the exchange, which means it is unnecessary to operate the terminal by answering the call. By combining the two methods, the caller only has to enter the telephone number of the called terminal and is relieved of all the other terminal operations, i.e. the communication connection to the called terminal is established automatically without further action by communication between the calling terminal and the exchange. The caller is almost unaware of the individual operations because they proceed very quickly, giving him the impression of having reached the called party by a normal call without call-back. The method according to the invention also has the advantage that it can be initiated by someone who is unfamiliar with the call-back process. In contrast to the method according to EP 1 062 822 B1, he is not confused by long response times.

The combined data message according to the invention does not have to be transmitted on the same path as the call-back. There is also the option of forwarding the data message to the exchange via other transmission paths, for example via a data network such as USSD, SMS, GPRS, WAP, e-mail and so on.

The second part of the purpose is fulfilled according to the invention by a terminal which is suitable for implementation of the method described above and in which the electronic circuit has a circuit module which generates a data message from the telephone number and the stored data set when the number is entered and transmits the data message to the exchange on a command through the input interface or automatically. For the reasons already stated above, the circuit module should be designed so that it breaks the connection to the exchange automatically after transmission of the data message and clears the terminal to take the call-back from the exchange and so that the circuit module then takes the call-back from the exchange automatically. In this way the call-back process proceeds fully automatically and only requires entry of the telephone number of the called terminal to initiate it.

The circuit module and/or the memory for the data set should preferably be located on a replaceable carrier so that existing terminals can also be equipped with it and will then be suitable for implementation of the call-back method according to the invention. If the terminal is a mobile phone, a SIM card is particularly suitable as a standardised carrier of data and programs.

An embodiment of the invention is illustrated diagrammatically on the drawing. It shows a communication system with a first mobile terminal A, a second mobile terminal B, a fixed terminal C and a first exchange D and a second exchange E, together with a data network F. In a first alternative, a connection can be established between the first terminal A and the first exchange D via a wireless link 2. Similarly, a communication connection can be established between the second terminal B and the first exchange D via a wireless link 3. Between the first exchange D and the fixed terminal C there is a land line link 4. The two exchanges D, E are connected via a land line link 5. As an alternative to the wireless link 2, a data link may be established between the first terminal A and the second exchange E via a data network F.

The first terminal A in the form according to the invention contains a circuit module x which stores a data set which—as described below—activates a call-back process to establish the connection between the first terminal A and the second terminal B or the fixed terminal C. The circuit module x also contains a logic circuit which supports the call-back process in the manner described below.

To initiate the call-back process, the caller enters, via an input interface—generally a keypad—the telephone number of the called terminal, that is either the number of the mobile second terminal B or that of the fixed terminal C. In the circuit module x the data set described above is added this telephone number to form a data message—combining the telephone number of the called terminal C or D and the data set. By means of a command via the input interface, the data message is transmitted to the second exchange E, either via the wireless link 2, the first exchange D and the land line link 5 or directly via the wireless link 1a, the data network F and the wireless link 1b. In the exchange E the identity of the first terminal A is determined and validated through the data set in the data message. The connection is then terminated, either by the first exchange E or by the action of the logic circuit in the circuit module x of the first terminal A, without the caller having to operate the first terminal A.

After validation of the identity, the second exchange E calls back the first terminal A via the land line link 4, the first exchange D and from there via the wireless link 2. If the first terminal A is available, i.e. is not engaged, and the electronic circuit x accepts the call, the call-back connection is established between the second exchange E and the first terminal A.

At the same time, the second exchange E calls either the second terminal B or the fixed terminal C—according to the telephone number—in the first case via the land line link 5, the first exchange D and the wireless link 3 and in the second case via the land line link 5, the first exchange D and the land line link 4. If the called terminal B or C is not engaged, a connection is established between the second exchange E and the called terminal B or C. The two connections then set up via the second exchange E are formed so that a communication connection is established between the calling first terminal A and either the second terminal B or the fixed terminal C—according to the telephone number entered in the calling terminal A.

The whole process takes place automatically, i.e. the caller with the first terminal A only needs to enter the telephone number of the second terminal B or the third terminal C in the first terminal A and give the command to establish the connection. All the other operations described above are then carried out by the second exchange E with the support of the circuit module x without the user of the first terminal A having to take action. The saving on charges for the caller is obtained because due to the call-back by the second exchange E, the call through the first terminal A is registered as a call by the called terminal B or C from the first exchange D and therefore the caller only has to pay the costs determined by the second exchange E which—if, for example, this exchange is in the USA—are much lower than the costs incurred for a standard call via the first exchange D.

It is understood that the configuration of the communication system shown on the drawing may be designed differently. It is optional whether the transmission of the data message from the first terminal A to the second exchange E takes place via the data network F or goes via the same connection as the call-back from the second exchange E to the first terminal A. It is also not essential for the connection from the second exchange E to the second terminal B or fixed terminal C to go through the first exchange D. It can also go through other exchanges or directly from the second exchange E.

1. Call-back method in a communication system for purposes of establishing a communication connection between a calling terminal (A) and a called terminal (B, C) accessible by a telephone number by switching of at least one exchange (E), whereby the telephone number is simply entered in the calling terminal (A) to initiate the communication connection and this activates transmission of a data set to the exchange and said data set then enables the exchange (E) to activate a call-back to the calling terminal (A) and a call to the called terminal (B, C) and to establish the communication connection between the two terminals (A, B or C), characterised in that after the telephone number of the called terminal has been entered in the calling terminal (A), the data set is automatically added to it and the resultant data message is transmitted to the exchange (E).

2. Call-back method according to claim 1, characterised in that after transmission of the data message the connection is automatically severed by the calling terminal (A).

3. Call-back method according to claim 1, characterised in that a call-back connection is established automatically by the calling terminal (A) on the basis of the call-back from the exchange (E).

4. Call-back method according to one of claims 1, characterised in that the data message is transmitted via a different data transmission path (F) from the call-back.

5. Terminal (A) to establish communication connections to other terminals (B, C) via at least one exchange (E), whereby the terminal (A) has an input interface and an electronic circuit (x) which has a memory for a telephone number of a called terminal (B, C) entered via the input interface and a data set which, after establishment of an outgoing call connection and transmission of the data set to the exchange (E), enables and activates the exchange to initiate a call-back from itself to the calling terminal (A) and to establish the communication connection between the two terminals (B, C), characterised in that the electronic circuit has a circuit module (x) which, when the telephone number is entered, composes a data message from that number and the stored data set and on a command transmits the data message to the exchange (E) via the input interface or automatically.

6. Terminal according to claim 5, characterised in that the circuit module (x) is designed to break the connection automatically after transmission of the data message and to clear the terminal (A) to take the call-back.

7. Terminal according to claim 5, characterised in that the circuit module (x) is designed to take the call-back automatically and therefore to establish a call-back connection.

8. Terminal according to one of claims 5, characterised in that the circuit module (x) is located on a replaceable carrier.

9. Terminal according to one of claims 5, characterised in that the memory for the data set is located on a replaceable carrier.

10. Terminal according to claim 9, characterised in that the replaceable carrier is in the form of a SIM card.
